(19) United States
(12) Patent Application Publication
(10) Pub. No.: US 2018/0271134 A1
(43) Pub. Date: Sep. 27, 2018

(54) THICKENED OIL/WATER FOOD EMULSION PACKAGED PRODUCTS WITH PROBIOTICS

(71) Applicant: The Clorox Company, Oakland, CA (US)

(72) Inventors: Vidya Ananth, Pleasanton, CA (US); Maria Ochomogo, Pleasanton, CA (US); Hubert Chan, Pleasanton, CA (US)

(21) Appl. No.: 15/465,452

(22) Filed: Mar. 21, 2017

(51) Int. Cl. A23L 33/135; A23L 27/00

(52) U.S. Cl. CPC A23L 33/135; A23V 2002/00; A23L 27/80

(57) ABSTRACT

Packaged emulsified food compositions (e.g., salad dressings including an oil/water emulsion) including a probiotic, which may be included therein, without requiring heating during packaging, and without requiring refrigeration for long term shelf stability. The probiotic may be sporeforming. In an embodiment the probiotic comprises spores which do not germinate until ingested by a consumer (e.g., such that the spores germinate in the intestinal tract of the consumer). The probiotic may comprise Bacillus coagulans spores, which may be added to the emulsion following addition of an acid. The salad dressing or other food composition advantageously can be cold packed, requiring no heating during manufacture, and no refrigeration after packaging, all while providing stability of 1 year or more.

### BACKGROUND OF THE INVENTION

### 1. The Field of the Invention

The present invention relates to packaged emulsified food compositions (e.g., oil and water salad dressings, or similar sauces).

### 2. Description of Related Art

Many consumers enjoy salad dressing on salad or other food items. Typically, salad dressings are carefully formulated not only in terms of the edible components included therein to provide great taste, but other characteristics, such as pH, rheology, stability, and the like are carefully selected to ensure characteristics other than taste are as desired. For example, such characteristics in addition to taste may include level of tartness (at least partially related to pH), pourability (related to rheology), and long term shelf stability. At the same time, there is an increased awareness and interest by consumers towards label ingredients included within such formulations, including a desire to avoid certain components that may be harmful, or perceived as harmful. In addition, there is a desire to include additional “healthy” components that would be desirable, if such could be accomplished without sacrificing characteristics such as those above (e.g., taste, pourability, stability, and the like). Because of the constraints associated with achieving such key characteristics, it can be difficult to reformulate a salad dressing to add (or remove) certain components, while still providing desired characteristics as described above.

### BRIEF SUMMARY

One aspect of the present invention relates to salad dressing formulations which include probiotics included therein. While various packaged foods are available that include probiotics, all such known packaged foods require thermal (heat) processing during packaging, refrigeration during storage, and/or low moisture content (e.g., sprayed onto a dry product). The present invention is directed to cold packed food products including significant moisture content, or low water activity, with a probiotic, and that are shelf stable for an extended period of time, where the packaged food product does not require refrigeration during storage nor hot packing during packaging. The presently described salad dressings advantageously provide such characteristics, e.g., including a probiotic, with shelf stability similar to that of traditional salad dressings or other packaged food products (e.g., up to a year or more), which stability consumers have come to expect. The ability to achieve such stability while including a probiotic in a cold packed product, while not requiring refrigeration, thermal processing, or low moisture content is surprising, unexpected, and advantageous.

Furthermore, such salad dressing formulations and methods may provide a product that exhibits comparable taste, pourability, stability, and similar characteristics, while including a probiotic included therein. Such inclusion of a probiotic (without sacrificing other key characteristics) allows for a perceptively improved ingredients label that is more attractive to at least some consumers.

According to one aspect of the present invention, a salad dressing or other packaged food product composition is disclosed, including water (or an oil/water emulsion comprising oil and water), a probiotic, and a food grade acid. The pH of the salad dressing or other packaged food product composition may be less than 4, the composition may be shelf stable for a period of at least 8 weeks (e.g., more typically at least 6 months, at least 12 months, or at least 18 months), without requiring refrigeration, and without requiring heating during packaging to achieve such stability.

Another aspect of the present invention is directed to a packaged food product composition (e.g., a salad dressing) including an oil/water emulsion comprising oil and water, a probiotic that is a sporeforming probiotic in which the probiotic includes spores that do not germinate until ingested by a consumer. The composition further includes a food grade acid, e.g., comprising at least at least one of acetic acid, citric acid, malic acid, gluconic acid, lactic acid, glucono decta lactone acid, fumaric acid, propionic acid, succinic acid, tartaric acid, phosphoric acid, or hydrochloric acid. The pH of the composition may be less than 4, and the composition is shelf stable for a period of at least 8 weeks without refrigeration, and without requiring heating during packaging. The composition including the probiotic may remain phase stable (i.e., it does not undergo a phase separation) upon addition of a buffer solution.

As will be appreciated by those of skill in the art, a sporeforming probiotic is a probiotic organism that is capable of surviving relatively harsh environments by concentrating genetic material of the cell, and by forming a protective coating around the cell, making it impervious to desiccation, heat, and/or many chemical agents. The coated cell (the spore) is capable of germinating into an active cell in a vegetative state, e.g., when the environment becomes less harsh (e.g., see P. R. Murray, W. L. Drew, G. S. Kobayashi, J. H. Thompson, Medical Microbiology, The C. V. Mosby Company, 1990, p. 8).

Another aspect of the present invention is directed to a method for producing such salad dressings or other packaged food product compositions, e.g., by providing water or an oil/water emulsion, adding a food grade acid to the water or emulsion, adding a sporeforming probiotic to the water or emulsion (e.g., after addition of the food grade acid) to form the salad dressing (or other food product composition), and packaging the composition into a container (e.g., a salad dressing bottle). No heat may be applied during the method (e.g., it is carried out under ambient temperature conditions), and the salad dressing or other food product composition as packaged may be shelf stable for a period of at least 6 months (or at least 12 months, or at least 18 months), without refrigeration.

By shelf stable, it is meant that the level of bacteria within the packaged salad dressing or other food product does not increase significantly, e.g., but remains substantially stable over the desired shelf life (e.g., 6 months, 12 months, or 18 months). For example, any increase (or decrease) may be limited to less than or equal to 2 log units through the given shelf life, or less than or equal to 1.5 log units, or less than or equal to 1 log unit, as will be demonstrated within the Examples provided herein. For example, this allows one to safely store the food product at ambient temperature in a sealed container for a specified period of time (e.g., at least about 8 weeks, at least about 6 months, at least about 12 months, at least about 18 months, etc.).

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings in which:

FIG. 1 shows initial CFUs per mL in exemplary salad dressing compositions inoculated with B. coagulans, for various scenarios;

FIG. 2 shows CFUs per mL in exemplary salad dressing compositions inoculated with B. coagulans, as tested over a period of 11 weeks, where the B. coagulans spores were not heat shocked;

FIG. 3 shows CFUs per mL in exemplary salad dressing compositions inoculated with B. coagulans, as tested over a period of 8 weeks, where the B. coagulans spores were heat shocked before inoculating the salad dressing composition with the heat shocked B. coagulans spores;

FIG. 4 shows CFUs per mL in exemplary salad dressing compositions inoculated with B. coagulans, as tested over a period of 8 weeks, where the salad dressing composition was inoculated with B. coagulans spores, and then the inoculated salad dressing compositions were heat shocked;

FIG. 5A is a microscope image of the solution described in Example 3 including the un-inoculated Ranch dressing composition diluted in BPB buffer solution; and

FIG. 5B is a microscope image of the solution described in Example 3 including the Ranch dressing composition inoculated with B. coagulans spores, diluted in BPB buffer solution.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “buffer” includes one, two or more buffers.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values include at least the variation to be expected in a typical formulation process, and may include values that are within 10%, within 5%, within 1%, etc. of a stated value. Furthermore, the terms “substantially”, “similarly”, “about” or “approximately” as used herein represent an amount or state close to the stated amount or state that still performs a desired function or achieves a desired result. For example, the term “substantially” “about” or “approximately” may refer to an amount that is within 10% of, within 5% of, or within 1% of, a stated amount or value.

Some ranges may be disclosed herein. Additional ranges may be defined between any values disclosed herein as being exemplary of a particular parameter. All such ranges are contemplated and within the scope of the present disclosure.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

The term “food safe” refers to compositions, which are comprised entirely of materials that are considered food grade, and/or Generally Recognized As Safe (GRAS) and/or Everything Added to Food in the U.S. (EAFUS). In the United States, ingredients pre-approved for food use are listed in the United States Code of Federal Regulations (“C.F.R.”), Title 21. Food safe materials may also include ingredients that are well established as safe, have adequate toxicological and safety pedigree, can be added to existing lists, or approved via a self-affirmation process.

In the application, effective amounts are generally those amounts listed as the ranges or levels of ingredients in the descriptions, which follow hereto. Unless otherwise stated, amounts listed in percentage (“%′s”) are in weight percent (based on 100% active) of the salad dressing formulation. With respect to the salad dressing formulation, the terms “salad dressing formulation”, “salad dressing composition” and “salad dressing product” are used interchangeably herein.

The phrase ‘free of’ or similar phrases as used herein means that the composition comprises 0% of the stated component, that is, the component has not been intentionally added to the composition. However, it will be appreciated that such components may incidentally form, under some circumstances, as a byproduct or a reaction product from the other components of the composition, or such component may be incidentally present within an included component, e.g., as an incidental contaminant.

The phrase ‘substantially free of’ or similar phrases as used herein means that the composition preferably comprises 0% of the stated component, although it will be appreciated that very small concentrations may possibly be present, e.g., through incidental formation, as a byproduct or a reaction product from the other components of the composition, incidental contamination, or even by intentional addition. Such components may be present, if at all, in amounts of less than 1%, less than 0.5%, less than 0.25%, less than 0.1%, less than 0.05%, less than 0.01%, less than 0.005%, or less than 0.001%.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. Introduction

In an aspect, the present invention is directed to salad dressing or other packaged food compositions which have been inoculated with a probiotic (e.g., beneficial bacteria), where the inoculated salad dressing or other packaged food product composition is shelf stable for an extended period of time, without requiring refrigeration and without requiring any heating during packaging. For example, the salad dressing composition may be cold packed (e.g., prepared and packaged at ambient temperature), without any requirement that the components be heated during preparation and/or packaging. In addition to not requiring “hot packing”, the finished composition does not require refrigeration once packaged in order to maintain its extended shelf life. For example, hot packing processes such as pasteurization to remove competing bacteria and/or refrigeration after packaging and during storage to slow bacterial growth might be expected to be needed to provide a food product including a probiotic therein, with extended shelf life. For example, the packaged salad dressing or other food product composition may remain stable (i.e., bacterial counts therein may remain substantially stable, e.g., rather than increasing) over a period of at least 8 weeks, at least 3 months, at least 6 months, at least 9 months, at least 12 months, at least 18 months, at least 24 months, at least 30 months, or at least 36 months, without any hot packing, and without refrigeration.

The probiotic included within the salad dressing or other food product composition may be a spore forming probiotic. In an embodiment, the probiotic included in the salad dressing may comprise spores of a spore forming bacteria (e.g., rather than, or in addition to germinated bacteria). Inclusion of the probiotic in the salad dressing provides a “cleaner” more desirable label relative to ingredients, which is appreciated by health-conscious consumers. In order to provide further “clean” labeling, various other components (for example calcium, in the form of calcium carbonate) may be included within the composition, and/or some components (e.g., MSG) typically present in such food product compositions may be omitted, providing an even further improved label. Further disclosure relative to inclusion of calcium carbonate (and/or omission of MSG) in such packaged food product compositions is found in Applicant's Patent Application bearing Attorney Docket No. 830.112, herein incorporated by reference in its entirety.

pH of the salad dressings according to the present invention may be greater than 2, but less than about 4. The relatively low pH aids in ensuring that the compositions are able to remain shelf stable for an extended period of time, even with high water concentrations typical of such salad dressing compositions, without a need for any thermal processing during manufacture and packaging, and without requiring refrigeration once the food product has been packaged. Such results are surprising, unexpected, and particularly beneficial, given that it allows the packaged food compositions to be stored in a similar manner as consumers and retailers are accustomed to, e.g., placing it on a shelf, unrefrigerated, for a period of months, or up to a year or more.

### III. Exemplary Salad Dressing and Other Food Product Formulations

A. Water, Oil, Probiotic, and Acid Components

Embodiments of the present food product compositions (e.g., a salad dressing) may include water (e.g., present as an oil-water emulsion), a probiotic, and a food grade acid (e.g., acetic acid). Other components, e.g., spices, milk solids, gum, starch, and the like, depending on the particular type of salad dressing or other packaged food product may also be included, as will be appreciated by those of skill in the art. The oil-water emulsion and many of the other components included within the salad dressing formulation may be according to traditionally employed, existing formulations, and the parameters of many of such will be appreciated by those of skill in the art. In at least some embodiments, the salad dressing formulation may be a dairy-based salad dressing (e.g., Ranch salad dressing).

Generally speaking, the amount of water in a formulation may be stated conversely as the amount of oil in a formulation, as the oil and water may make up the vast majority of the formulation constituents. Generally, when the amount of oil in a formulation is decreased (e.g., for reduced calorie purposes), the oil may be replaced with water. As such, it will be apparent that the oil/water ratio may be dependent upon the desired caloric content of the product, with reduced oil and increased water content in reduced calorie formulas. For a fat-free salad dressing formulation, no oil may be added, but rather just water (i.e., replacing the typical oil/water emulsion with just water).

All else being equal, increased water content may increase the potential for microbiological activity, increasing risk that the composition may not be shelf stable. In other words, with relatively high water content as in any salad dressing formulation (whether fat-free or not), it is surprising that a probiotic may be added to the formulation, without such probiotic and/or other competing microbes multiplying exponentially, leading to spoilage within a short period of time. It will be apparent that altering the oil/water ratio may be paired with adjustments to any preservative system included in the composition. Altering the oil/water ratio may also affect the rheology characteristics of the product, affecting pourability, spoon-ability and similar characteristics, with increased oil content typically correlating to increased thickness and viscosity. The oil/water ratio may also affect the “mouth feel” of the product.

Any suitable edible oils may be used in an oil-water emulsion of the salad dressing. Typical examples include triglyceride oils derived from seeds, for example, corn oil, soybean oil, safflower oil, canola oil, olive oil, sesame oil, cottonseed oil, the like, and mixtures thereof. Any food grade oil may be used. The amount of oil present in a salad dressing formulation may vary from 0% (for a fat free formulation) to about 90% or more, typically in amounts up to about 70%. In some embodiments, the amount of oil may be from about 40% and about 90% by weight.

The water content may vary from about 5% to about 90%, from about 5% to about 50% by weight, e.g., from about 30% to about 90% for pourable or squeezable formulations, and from about 5% to about 65% for relatively thicker formulations such as those intended to be spooned out of the container (such formulations can also be dispensed by inverting and squeezing a squeezable container). The ability to provide a packaged food product that does not require thermal processing (i.e., hot packing), or refrigeration, while including a probiotic, all while including such relatively high concentrations of water, is particularly beneficial, and surprising and unexpected. By way of example, the water content of the salad dressing or other food product composition may be at least 5%, at least 10%, at least 15%, at least 20%, at least 25%, at least 30%, not more than 95%, not more than 90%, not more than 85%, not more than 80%, not more than 75%, not more than 70% by weight, or within any range defined between any two such values.

Any desired loading of the probiotic may be included in the food product composition. In one example, the composition may include 3×10⁹ CFUs per serving (e.g., 2 tablespoons (about 29 mL)). The loading in the inoculated salad dressing or other food product composition may be from about 1×10¹ CFUs/mL to about 1×10¹⁰ CFUs/mL, from about 1×10² CFUs/mL to about 1×10¹⁰, from about 1×10³ CFUs/mL to about 1×10¹⁰ CFUs/mL, from about 1×10⁴ CFUs/mL to about 1×10¹⁰ CFUs/mL, from about 1×10⁵ CFUs/mL to about 1×10¹⁰, from about 1×10⁶ CFUs/mL to about 5×10⁹ CFUs/mL, or from about 1×10⁷ CFUs/mL to about 1×10⁹ CFUs/mL (e.g., about 1×10⁸ CFUs/mL) per serving.

Although the loading of the probiotic may be described herein in the context of salad dressing formulations including an oil-water emulsion, it is within the scope of the invention to use the concepts described herein in formulations which may include little or no oil component, or a salad dressing in which the oil and aqueous phases intentionally separate (e.g., Italian salad dressing), depending on the particular characteristics desired in the salad dressing or other food product composition.

The included probiotic may be any desired bacteria or other microbe that is beneficial once ingested into the consumer's digestion tract. In an embodiment, the probiotic may be a sporeformer (i.e., capable of forming spores). The probiotic may be from the genus Bacillus (e.g., Bacillus sp.). A particular example of a suitable sporeforming bacteria is Bacillus coagulans. Such Bacillus coagulans spores have been found to be capable of being cold packed into a salad dressing composition, such that the composition remains stable over a year or more.

In an embodiment, the probiotic introduced into the salad dressing or other food product composition may comprise spores of the sporeformer. In an embodiment, the probiotic may include only spores, rather than germinated, non-dormant probiotics. For example, the spores may be incorporated into the food product composition in a manner that no germination or growth occurs until the composition is ingested by the consumer. Upon consumption of the composition, the spores may germinate within the digestive tract of the consumer (e.g., within the gut, once past the stomach). Use of sporeformers and/or spores may aid in regulating growth of any competing bacteria or other microbes that may be present in the gut.

As will be described in further detail herein, there is no requirement that the sporeformer or other probiotic be heat shocked in otherwise shocked in order to activate the probiotic. For example, it is believed that heat shock, nitrogen activation, ascorbic acid activation, or other activation may be required for some other products including probiotics, in order for the probiotic to provide the desired benefit to the consumer. No such heat shock or other activation is required in the present invention.

Where the salad dressing or other food product composition includes an oil/water emulsion, the probiotic may be present at the interphase between the oil phase and the water phase of the emulsion. The probiotic (e.g., spores) may adsorb onto the interphase between the two phases, stabilizing the emulsion, and further preventing separation of the two phases of the emulsion. The probiotic may thus form a Pickering emulsion, with increased stability as compared to if the probiotic were not present. Thus, in addition to providing a cleaner label, with a desirable ingredient (the probiotic), the addition of the probiotic may further serve to increase the stability of the emulsion, where the salad dressing or other food product composition is in the form of an oil/water emulsion.

The food product composition, particularly a salad dressing, may include one or more food grade acids. In an embodiment, the food grade acid may comprise acetic acid. In some embodiments, acetic acid may be the only included acid. In other embodiments, other acids may alternatively or additionally be used. For example, edible acids suitable for use in salad dressing formulations may include soluble, partially soluble, sparingly soluble, and substantially insoluble mineral and organic acids, including combinations of acids. Corresponding conjugate acid salts of such acids may also be suitable, including, but not limited to mono-carboxylic acids, di-carboxylic acids, tri-carboxylic acids, nitrogen based acids, and combinations thereof. Specific examples of such edible acids include acetic acid (vinegar), citric acid, malic acid, gluconic acid, lactic acid, glucono decta lactone acid, fumaric acid, propionic acid, succinic acid, tartaric acid, phosphoric acid, hydrochloric acid, derivatives or isomers of any of the foregoing, conjugate salts thereof, or combinations thereof.

The amount of acid (e.g., acetic acid) may be from 0.001% to 10%, from 0.001% to 5%, from 0.001% to 2%, from 0.1% to 1%, from 0.2% to 0.8%, or from 0.5% to 0.8% (e.g., 0.5%, 0.6%, 0.7%, 0.8%, 0.9%, 1%, or any other values between the above ranges).

The present formulations preferably employ a food grade acid, which may be added to the dressing formulation near the end of its preparation, before addition of the probiotic. For example, other than probiotic addition, the acid may be the last component added. Under the acidic conditions typically present (e.g., a pH of about 4 or less), the probiotic has been found to be stable, e.g., so that the loading (e.g., CFUs/mL) in the inoculated salad dressing or other food product composition remains substantially stable from the time of packaging, through the contemplated shelf life of the product (e.g., at least 6 months, at least 12 months, up to 3 years, or the like). In some embodiments, acetic acid may be the only added acid (e.g., the composition may be free of one or more of lactic acid, other organic acids, phosphoric acid, or other mineral acids).

In order to aid in maintaining the desired acidic pH, a buffer may be present in the formulation. While sodium containing buffers have commonly been used, in some embodiments, any included buffer is not a sodium salt. For example, salts of magnesium, potassium and particularly calcium may be more preferred. Such buffers may be carbonates, bicarbonates, hydrates thereof, and the like.

B. Other Components

In addition to the above described components provided in the salad dressing, various other components may be provided as would be typical in providing desired flavor and other characteristics.

Salt (sodium chloride) may be included in the salad dressing formulations, typically up to about 2% by weight. Of course, relatively more or less salt may be included to achieve a specific flavor.

A sweetener, such as sugar, corn syrup, or other sweeteners may be added to a salad dressing to provide a sweet flavor, to decrease the perceived tartness of the dressing, or both. Of course, where a “clean” label is desired, it may be advantageous to avoid inclusion of high fructose corn syrup, other corn syrup, or other highly processed sweeteners. In such embodiments, if any sweetener is present, sugar or a non-nutritive sweetener (e.g., any of the various sugar alcohols) may be employed. Combinations of sweeteners may of course be employed.

An antimicrobial inhibitor (i.e., preservative) may be included, including, but not limited to a benzoate, sorbate, sorbic acid, or combinations thereof. Specific examples include, but are not limited to sorbic acid, sodium benzoate, potassium benzoate, potassium sorbate, nisin and natamycin or the like. Natural antimicrobial inhibitors (e.g., nisin and natamycin) may be preferred.

An exemplary salad dressing formulation may include components with weight percentages as shown in Table 1 below.

TABLE 1
Example 1

| Component | Weight Percent |
|---|---|
| Water | 30-50 |
| Edible Oil | 30-70 |
| Preservative | 0.05-5 |
| Phosphoric or Another Acid | 0.2-2 |
| Other Edible Acids | 0-2 |
| Buffer | 0.01-2 |
| Probiotic | 1 × 10¹⁻⁹ CFUs/mL |
| Miscellaneous | Balance |

The Example shown in Table 1 includes a relatively high fraction of oil, e.g., such as may be employed in an “Original” full calorie type formulation, rather than a reduced calorie formulation. A reduced fat or reduced calorie formulation may include a lower fraction of oil, and more water, e.g., as shown below in Table 2. Of course, a fat-free formulation may include no or negligible Edible Oil component (e.g., 0%, less than 5%, less than 3%, less than 2%, or less than 1%).

TABLE 2
Example 2

| Component | Weight Percent |
|---|---|
| Water | 50-65 |
| Edible Oil | 15-30 |
| Preservative | 0.05-5 |
| Phosphoric or Another Acid | 0.2-2 |
| Other Edible Acids | 0-2 |
| Buffer | 0.01-2 |
| Probiotic | 1 × 10¹⁻⁹ CFUs/mL |
| Miscellaneous | Balance |

“Miscellaneous” ingredients may include edible ingredients, such as those added principally for flavor, or for other purposes, and may depend on the specific flavor of salad dressing or other food product being formulated. Examples include, but are not limited to savory flavors (e.g., hydrolyzed vegetable protein, inosinates and guanylates); meat and meat flavors (e.g., bacon, bacon flavor); dairy and/or egg products (e.g., buttermilk, sour cream, blue cheese, whole egg), both liquid and dehydrated; vegetables and vegetable flavors (e.g., bell pepper, pickles, onion), fresh or dehydrated; herbs and spices (e.g., pepper, parsley, dill, thyme, sage, oregano), either fresh or dehydrated; natural or artificial flavors; extracts; emulsifiers (e.g., polysorbate 60, egg yolk); gums and starches (e.g., xanthan, guar, locust bean, carrageenan) and/or other edible additives included to alter taste or to provide some other particular characteristic. Additional examples of miscellaneous ingredients are disclosed in U.S. Pat. No. 4,927,657 to Antaki, herein incorporated by reference in its entirety.

While MSG is often included in existing salad dressing formulations as a flavor enhancement, in at least some embodiments, in order to improve the cleanliness of the label, no MSG may be included. While MSG can serve as a flavor enhancer, or provide other function, inclusion of MSG is problematic to some consumers, so that its absence may be helpful. Where MSG is omitted, the pH of the composition may correspondingly be lower (e.g., drop by about 1 pH point, to a pH of less than about 3), or additional buffer or other pH adjusting agent may be included to ensure a desired pH (e.g., 3 to about 4, or 3.4 to about 4).

pH of the salad dressing formulation in some embodiments may be less than about 4, e.g., from 2.2 to about 4, less than 4.2, less than 4.1, such as 3.2, 3.3, 3.4, 3.5, 3.6, 3.7, 3.8, or 3.9. In other embodiments, the pH of the salad dressing formulation may be lower, e.g., 3.0, 2.9, 2.8, 2.7, 2.6, 2.5, 2.4, 2.3, or 2.2. In any case, at least for a dairy based salad dressing such as a Ranch or Blue Cheese salad dressing, the pH will be less than about 4. Of course, other types of salad dressings (Italian, French, Catalina, and the like) may have a pH value similar or somewhat different as compared to those mentioned above, and in some cases, this may be even greater than a pH of 4. The target low pH may be an important characteristic in providing stability while including a probiotic, as shown in the Examples below.

To further the goal of providing a clean label, a sodium containing buffer such as disodium phosphate may not be used, but rather another buffer may be used instead (e.g., a calcium containing buffer). In some embodiments, the salad dressing formulation may not include sodium containing buffers, other than sodium chloride (included for taste, not buffering). As described herein, some consumers may prefer a “cleaner” label that does not include or at least minimizes such sodium containing components, particularly where a calcium containing component may be employed instead.

### IV. Experimental Data

The inventors performed various tests to show that a probiotic (e.g., such as a sporeforming probiotic) can be incorporated into a salad dressing packaged food product, without requiring heating during packaging, while maintaining stability over a shelf life of months, and without requiring refrigeration.

### Example 1

Example 1 was conducted to verify the feasibility of adding probiotics to an aqueous, liquid packaged food product that would not require hot packing, nor refrigeration after packaging to achieve stability. To demonstrate the survival and growth of B. coagulans in tryptic soy broth (“TSB”) at various pH values, TSB broth was inoculated with heat shocked and non-heat shocked cultures of B. coagulans. 0.2 g of lyophilized B. coagulans was added to 10 mL of TSB. This mixture was vortexed and divided into two 5 mL samples. One of the 5 mL samples was heat shocked at 80° C. for 10 minutes, while the other 5 mL sample was not heat shocked. 10 mL TSB solutions at various pH values (7.1, 4.1, 3.84, and 3.46) were prepared as shown in Table 3, below. Two samples of each of Examples 1A-1D were prepared.

TABLE 3

| Sample | pH | Added Phosphoric Acid |
|---|---|---|
| Example 1A | 7.1 | — |
| Example 1B | 4.1 | 40 μL of 75% H₃PO₄ |
| Example 1C | 3.84 | 50 μL of 75% H₃PO₄ |
| Example 1D | 3.46 | 55 μL of 75% H₃PO₄ |

Each solution of Examples 1A-1D was incubated at 35° C. 1 mL of the non-heat shocked B. coagulans TSB solution was added to each of the first TSB solutions of Table 3 (as there were two of each). 1 mL of the heat shocked B. coagulans TSB solution was added to each of the second TSB solutions of Table 3, resulting in the 8 samples as shown below in Table 4.

TABLE 4

| Sample | pH |
|---|---|
| Example 1A - HS | 7.1 |
| Example 1A - non-HS | 7.1 |
| Example 1B - HS | 4.1 |
| Example 1B - non-HS | 4.1 |
| Example 1C - HS | 3.84 |
| Example 1C - non-HS | 3.84 |
| Example 1D | 3.46 |
| Example 1D - non-HS | 3.46 |

Next, dilutions from 10⁻² to 10⁻⁷ were prepared from 1 mL of each of the TSB solutions from Table 4, added with 9 mL of Butterfield Phosphate Buffer (“BPB”). Dilutions at 1:10⁻², 1:10⁻³, 1:10⁻⁴, 1:10⁻⁵, 1:10⁻⁶, and 1:10⁻⁷ were prepared. 100 μL of each dilution where spread plated on tryptic soy agar (“TSA”) plates. The plates were incubated at 35° C. for 48 hours before the colony forming units (“CFUs”) were counted. At day 1, day 4, day 6, and day 8, day 11, and day 21 1 mL aliquots were taken from each sample of Table 4, and they were diluted (i.e., from 10⁻² to 10⁻⁷) and plated as above. Results are shown in Tables 5A-5D, below.

TABLE 5A
Non-Heat Shocked

| | Day 0 | Day 1 | Day 4 | Day 6 | Day 8 | Day 11 | Day 21 |
|---|---|---|---|---|---|---|---|
| | Log | Log | Log | Log | Log | Log | Log |
| pH | (CFUs/mL) | (CFUs/mL) | (CFUs/mL) | (CFUs/mL) | (CFUs/mL) | (CFUs/mL) | (CFUs/mL) |
| 7.1 | 7.4 | 5.796 | 8.778 | 8.585 | 9.147 | 10.055 | 9.998 |
| 4.1 | 7.34 | 6.044 | 6.223 | 6.484 | 7.412 | * | * |
| 3.84 | 7.36 | 7.233 | 6.929 | 6.728 | 7.633 | 6.979 | 7.435 |
| 3.46 | 7.33 | 5.301 | 6.799 | 6.647 | 7.457 | 6.808 | * |

TABLE 5B
Non-Heat Shocked

| | Day 0 | Day 1 | Day 4 | Day 6 | Day 8 | Day 11 | Day 21 |
|---|---|---|---|---|---|---|---|
| | St. | St. | St. | St. | St. | St. | St. |
| | Dev.Log | Dev.Log | Dev.Log | Dev.Log | Dev.Log | Dev.Log | Dev.Log |
| pH | (CFUs/mL) | (CFUs/mL) | (CFUs/mL) | (CFUs/mL) | (CFUs/mL) | (CFUs/mL) | (CFUs/mL) |
| 7.1 | 0.00 | 0.025 | 0.031 | 0.008 | 0.042 | 0.024 | 0.023 |
| 4.1 | 0.025 | 0.050 | 0.092 | 0.010 | 0.020 | * | * |
| 3.84 | 0.00 | 0.025 | 0.007 | 0.148 | 0.014 | 0.035 | 0.006 |
| 3.46 | 0.003 | 0.000 | 0.029 | 0.168 | 0.048 | 0.052 | * |

* mold contamination observed

TABLE 5C
Heat Shocked

| | Day 0 | Day 1 | Day 4 | Day 6 | Day 8 | Day 11 | Day 21 |
|---|---|---|---|---|---|---|---|
| | Log | Log | Log | Log | Log | Log | Log |
| pH | (CFUs/mL) | (CFUs/mL) | (CFUs/mL) | (CFUs/mL) | (CFUs/mL) | (CFUs/mL) | (CFUs/mL) |
| 7.1 | 8.000 | 5.804 | 7.291 | 7.376 | 8.276 | 9.158 | 9.084 |
| 4.1 | 7.716 | 6.364 | 6.568 | 6.867 | 7.601 | 6.831 | 7.656 |
| 3.84 | 7.556 | 6.461 | 6.763 | 6.924 | 7.547 | 6.812 | 6.705 |
| 3.46 | 7.842 | 6.284 | 6.672 | 6.685 | 7.384 | 6.708 | 7.176 |

TABLE 5D
Heat Shocked

| | Day 0 | Day 1 | Day 4 | Day 6 | Day 8 | Day 11 | Day 21 |
|---|---|---|---|---|---|---|---|
| | St. | St. | St. | St. | St. | St. | St. |
| | Dev.Log | Dev.Log | Dev.Log | Dev.Log | Dev.Log | Dev.Log | Dev.Log |
| pH | (CFUs/mL) | (CFUs/mL) | (CFUs/mL) | (CFUs/mL) | (CFUs/mL) | (CFUs/mL) | (CFUs/mL) |
| 7.1 | 0.015 | 0.058 | 0.064 | 0.048 | 0.006 | 0.004 | 0.023 |
| 4.1 | 0.113 | 0.028 | 0.017 | 0.058 | 0.006 | 0.117 | 0.081 |
| 3.84 | 0.13 | 0.042 | 0.032 | 0.000 | 0.078 | 0.090 | 0.073 |
| 3.46 | 0.241 | 0.005 | 0.026 | 0.032 | 0.003 | 0.078 | 0.0102 |

The testing conducted in Example 1 confirmed that the bacterial inoculum remained stable over 21 days for both the heat shocked and non-heat shocked samples at pH values of 4.1 and below. At pH of 7.1, both the heat shocked and non-heat shocked samples did not remain stable, but increased significantly.

### Example 2

Example 2 was conducted to demonstrate that B. coagulans count remains stable in a Ranch salad dressing, and how heat shocking affects the B. coagulans count.

### Non-Heat Shocked Procedure

1 g of lypholized B. coagulans was added to 10 mL DI water and vortexed for 2 minutes. The source of the B. coagulans reports 15×10⁹ cells/g, therefore the starter culture above had 15×10⁸ cells/mL.

3 mL of the starter culture was added to 500 g of Ranch dressing (e.g., Hidden Valley Ranch). Three such samples were prepared, labeled AL1, AL2, and AL3. Another sample of Ranch dressing was prepared with no added B. coagulans inoculum. The approximate cell count in 500 mL is therefore 9×10⁶ cells/mL (6.95 log). The inoculated samples of Ranch dressing were hand stirred for 2 minutes using 25 mL pipettes. The inoculated samples were then shaken for 5 minutes on a shaker (e.g., a wrist action shaker). The un-inoculated sample was not stirred or shaken on the shaker.

1:10 dilution of the un-inoculated and inoculated samples were prepared in Stomacher bags. For preparation of the 1:10 Stomacher bag dilution, 25 g of the appropriate Ranch dressing sample (inoculated or un-inoculated) was added to 225 g of BPB buffer. Using BPB buffer, dilutions from 10⁻² to 10⁻⁷ were prepared in a similar manner as described in Example 1, by adding 1 mL of the 1:10 dilution to the diluting BPB buffer, to achieve the desired dilutions. 100 of each of the dilutions starting from 1:100 were plated on TSA plates. Plates were counted after 48 hours of incubation at 35° C. During the course of the study, the Ranch dressing samples were stored at 35° C.

### Heat Shock Pre-Inoculating Procedure

The supplier of the B. coagulans reports 15×10⁹ cells/g. The starter culture of B. coagulans was prepared by adding 1 g of lypholized B. coagulans to 10 mL of sterilized distilled water (DI). The starter culture was thoroughly vortexed for 2 minutes. Therefore the starter culture had 15×10⁸ cells/mL. The starter culture was heat shocked for 10 minutes by placing it in a water bath at 80° C. Next, 1.5 mL of the heat shocked starter culture was added to 250 g of Ranch dressing. Three such samples (labeled A1, A2, and A3) were prepared. A sample of Ranch dressing without any added B. coagulans inoculum was also prepared (labeled UnA). Target starting inoculum level was 9×10⁶ cells/mL (6.95 log) in 250 g of Ranch dressing, for the inoculated samples (A1, A2, and A3).

The inoculated samples were hand mixed for 2 minutes using a 25 mL serological pipette. Next, the inoculated samples were shaken for 5 minutes using a wrist action shaker at 250 oscillations/min. The un-inoculated samples were not shaken by hand nor on the wrist action shaker. For each sample, 1:10 dilution was prepared by adding 25 g of Ranch dressing to one side of a Stomacher bag, and adding BPB buffer to bring up the mixture to 250 g. Next, each of the 1:10 dilutions were mixed in the stomacher bag at 230 rpm for 2 minutes. Next, each of the 1:10 dilution bags were further diluted to the desired dilution (i.e., all the way up to 10⁻⁷). From each of the dilutions, 100 μL were plated on a TSA plate.

### Heat Shock Post-Inoculating Procedure

Target inoculum level in the 30 g of Ranch dressing is 9×10⁶ cells/mL (log 6.95). The starter culture of B. coagulans was prepared by adding 1 g of lypholized B. coagulans to 10 mL of sterilized distilled water (DI). The starter culture was thoroughly vortexed for 2 minutes. 180 μL of the starter culture was added to a test tube containing 30 g of Ranch dressing. Three such samples were prepared, labeled AHS, BHS, and CHS. Also, an un-inoculated 30 g sample of Ranch dressing was prepared, labeled UNHS. These 4 samples were placed in an 80° C. water bath for 10 minutes.

The inoculated samples were hand mixed using a 1 mL serological pipette. Next, the inoculated samples were shaken for 5 minutes using a wrist action shaker at 250 oscillations/min. The un-inoculated samples were not shaken by hand nor on the wrist action shaker. For each sample, 1:10 dilution was prepared by adding 1 g of the sample salad dressing to a 50 mL flip-top tube, and BPB buffer was added to bring up the mixture to 10 g, using a balance. Next, each of the 1:10 dilutions were mixed in the stomacher bag at 230 rpm for 2 minutes. Next, each of the 1:10 dilution bags were further diluted to the desired dilution (i.e., all the way up to 10⁻⁷). From each of the dilutions, 100 μL were plated on a TSA plate. The plates were incubated at 35° C. for 48 hours before the CFUs on the plates were counted. Both the pre-inoculated heat shock samples, and the post-inoculated heat shock samples were stored at 37° C. during the course of the study.

### Results

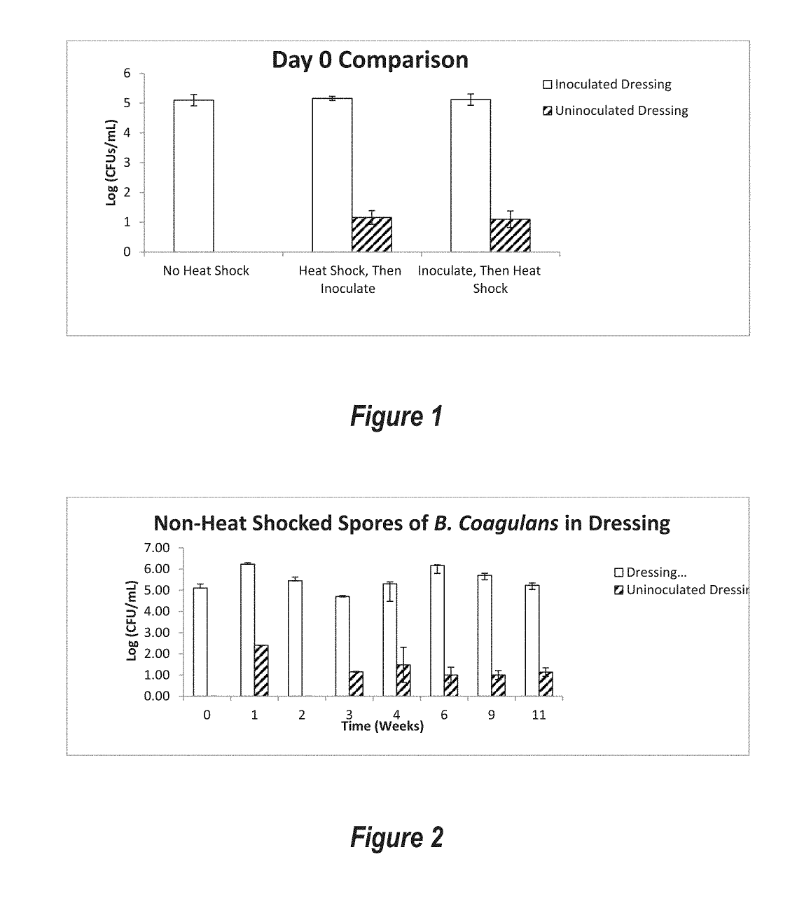

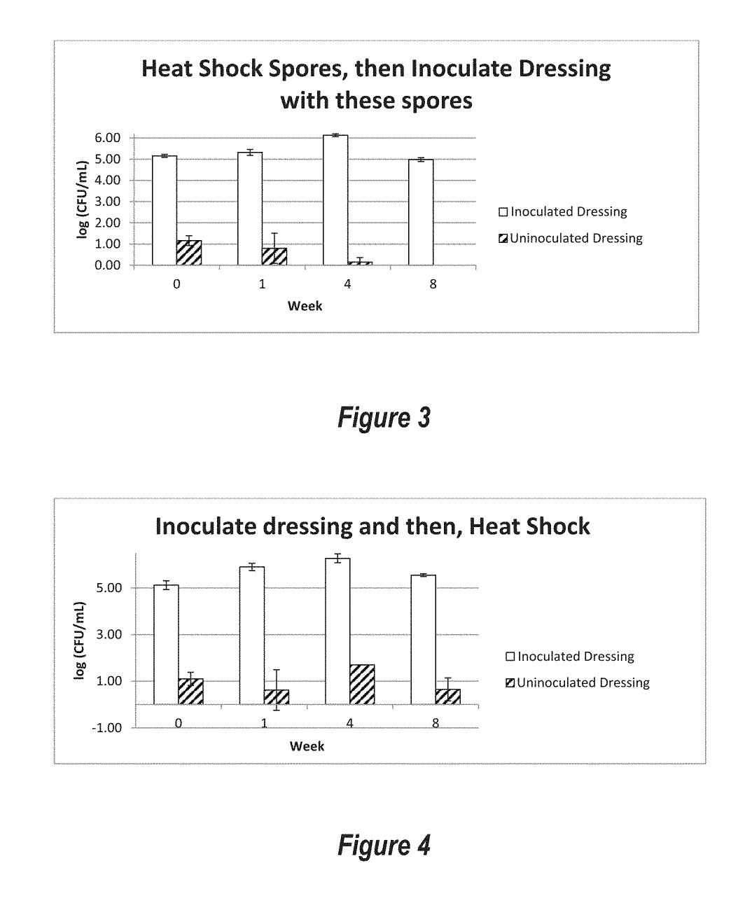

Stability of the B. coagulans in the salad dressing compositions was evaluated over a period of several weeks. The results are shown in FIGS. 1-4. FIG. 1 shows the starting (Day 0) probiotic counts for the non-heat shocked, the pre-inoculated heat shocked, and the post-inoculated heat shocked samples, compared to one another and to the un-inoculated salad dressing. The starting counts were about log 5. FIG. 2 shows results for the non-heat shocked samples. FIG. 3 shows results for the pre-inoculated heat shocked samples. FIG. 4 shows results for the post-inoculated heat shocked samples. Each Figure shows data over a period of 8 to 11 weeks. The counts for the 3 methods of adding probiotic to the salad dressing remained substantially stable over the test period. The counts for the non-heat shocked samples increased from day 0 to week 1, (from about 5.1 log to 6.23 log), which could be attributed to sample to sample variation. In any case, all three methods of probiotic addition showed acceptable shelf stability over the test period. Such results indicate a viable 12 month shelf life for a salad dressing inoculated with such a probiotic. For example, any increase in CFU count may be limited to no more than 2 log (e.g., from 5.1 log to 7.1 log), no more than 1.5 log (e.g., from 5.1 log to 6.6 log), no more than 1 log (e.g., from 5.1 log to 6.1 log), or no more than 0.5 log (e.g., from 5.1 log to 5.6 log) over such shelf life period.

Testing samples that undergo a pre-innoculation heat shock treatment serve to eliminate any bacteria that may be present in a vegetative state, ensuring the purity of the tested sample. Testing samples that undergo a post-inocculation heat shock treatment serve to ensure that any background microflora that may be present in the composition are eliminated. The no-heat shock samples serve as a comparison to both tested varieties.

### Example 3

Example 3 was conducted to observe microscopic behavior of B. coagulans inoculated salad dressing compositions as compared to otherwise identical, but un-inoculated dressing compositions, upon addition of a buffer.

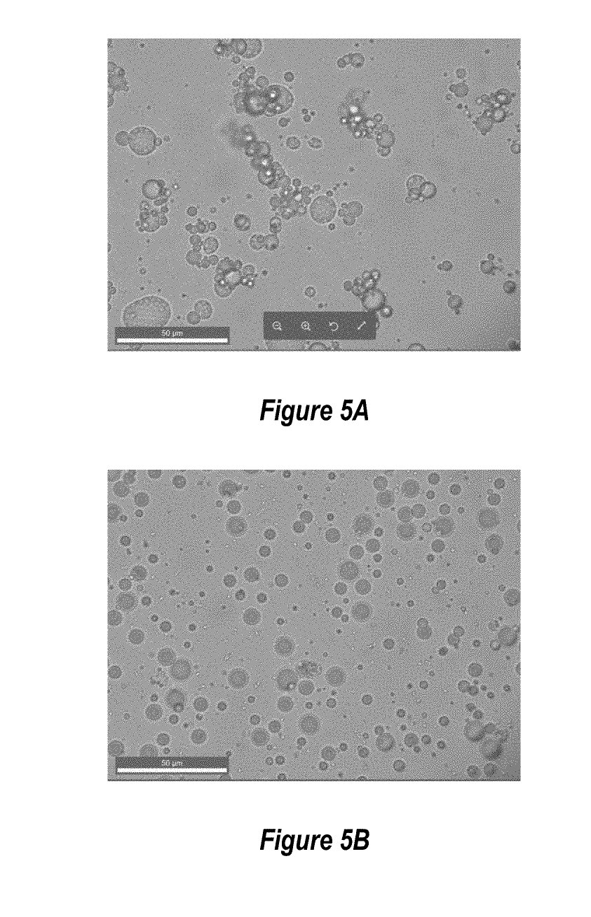

2 mL of Ranch dressing, both with B. coagulans (1×10⁵-1×10⁶ CFU/mL) and without B. coagulans was added to 9 mL of BPB (pH of 7.1), obtained from Hardy diagnostics. Each solution was mixed well for 30 seconds, and prepared for optical microscopy by placing a drop of each sample in between a glass slide and a cover sheet. A Leica DM2500P optical microscope with a 63× objective was used to observe the emulsion phases, as well as the B. coagulans present in the inoculated sample, as compared to the un-inoculated sample. The results are shown in FIGS. 5A-5B. The diluted solutions were also kept in vials and observed after 10 minutes, 30 minutes, and 24 hours.

FIG. 5A shows a microscope image of the diluted Ranch salad dressing composition without addition of any probiotic. This image shows aggregates of oil droplets suspended in an aqueous phase, typical of an unstable emulsion system. FIG. 5B however shows the diluted Ranch salad dressing composition that included Bacillus coagulans, which image shows substantially uniformly dispersed oil droplets. The oil droplets in FIG. 5B are also more uniformly sized, as compared to the greater variability seen in FIG. 5A. The generally tennis-racket shaped Bacillus coagulans spores (3-4 microns in length) can be seen at many oil-water interfaces (or interphases) in FIG. 5B, suggesting the formation of a Pickering emulsion system. Excess spores are also seen (e.g., suspended) in the aqueous phase between oil droplets.

The diluted solutions kept and observed in vials showed that the sample containing Bacillus coagulans remained an opaque, substantially homogenous emulsion throughout the duration of the study. However, the sample without the probiotics (that of FIG. 5A) quickly phase separated (within a few minutes), consistent with the microscopy results seen in FIGS. 5A-5B. Thus, the addition of probiotics to the salad dressing composition further stabilized the emulsion, causing it to maintain its emulsion state, even upon addition of a buffer.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

1. A food composition comprising:
(a) water or an oil/water emulsion comprising oil and water;
(b) a probiotic;
(c) a food grade acid;
wherein a pH of the food composition is less than 4, and wherein the food composition is shelf stable for a period of at least 8 weeks without refrigeration, and without requiring heating during packaging.

2. The food composition of claim 1, wherein the food composition has a pH in a range of 2 to less than 4.

3. The food composition of claim 1, wherein the probiotic is a sporeforming probiotic.

4. The food composition of claim 3, wherein the probiotic comprises spores that do not germinate until ingested by a consumer.

5. The food composition of claim 1, wherein the probiotic comprises Bacillus coagulans.

6. The food composition of claim 1, wherein (a) is the oil/water emulsion comprising oil and water.

7. The food composition of claim 6, wherein the probiotic is present at an interphase between an oil phase and a water phase of the oil/water emulsion.

8. The food composition of claim 1, wherein the food composition is shelf stable for a period of at least 6 months, or at least 12 months, without refrigeration, and without requiring heating during packaging.

9. The food composition of claim 1, wherein the food grade acid comprises at least one of acetic acid, citric acid, malic acid, gluconic acid, lactic acid, glucono decta lactone acid, fumaric acid, propionic acid, succinic acid, tartaric acid, phosphoric acid, or hydrochloric acid.

10. A food composition comprising:
(a) an oil/water emulsion comprising oil and water;
(b) a probiotic that is a sporeforming probiotic, the probiotic comprising spores that do not germinate until ingested by a consumer;
(c) a food grade acid including at least one of acetic acid, citric acid, malic acid, gluconic acid, lactic acid, glucono decta lactone acid, fumaric acid, propionic acid, succinic acid, tartaric acid, phosphoric acid, or hydrochloric acid;
wherein a pH of the food composition is less than 4, wherein the probiotic is shelf stable for a period of at least 8 weeks without refrigeration, and without requiring heating during packaging;
wherein the food composition does not phase separate upon addition of a buffer, but remains as a stable emulsion.

11. The food composition of claim 10, wherein the probiotic comprises Bacillus coagulans.

12. The food composition of claim 10, wherein the probiotic is present at an interphase between an oil phase and a water phase of the oil/water emulsion.

13. The food composition of claim 10, wherein the food composition is shelf stable for a period of at least 12 months, or at least 18 months, without refrigeration, and without requiring heating during packaging.

14. A method for producing a food composition including a probiotic, the method comprising:
(a) providing water or an oil-water emulsion comprising oil and water;
(b) adding a food grade acid to the water or emulsion;
(c) adding a sporeforming probiotic to the water or emulsion after addition of the food grade acid to form the food composition; and
(c) packaging the food composition into a container;
wherein no heat is applied during the method, wherein the food composition is shelf stable for a period of at least 6 months without refrigeration.

15. The method of claim 14, wherein the food composition has a pH less than 4.

16. The method of claim 14, wherein the sporeforming probiotic is added to the acidified water or emulsion via high shear mixing.

17. The method of claim 14, wherein the sporeforming probiotic comprises spores that do not germinate until ingested by a consumer.

18. The method of claim 14, wherein the food composition is shelf stable for a period of at least 12 months without refrigeration.

19. The method of claim 14, wherein the sporeforming probiotic comprises Bacillus coagulans.

20. A food composition comprising:
(a) water;
(b) a probiotic;
(c) a food grade acid;
wherein a pH of the food composition is less than 4, and wherein the food composition is shelf stable for a period of at least 8 weeks without refrigeration, and without requiring heating during packaging.
